(19) United States
(12) Patent Application Publication
(10) Pub. No.: US 2024/0424820 A1
(43) Pub. Date: Dec. 26, 2024

(54) DEVELOPER COMPOSITION FOR PHENOL-FREE DIRECT THERMAL RECORDING MEDIA

(71) Applicant: Appvion, LLC, Appleton, WI (US)

(72) Inventor: Mark R. Fisher, Appleton, WI (US)

(73) Assignee: Appvion, LLC, Appleton, WI (US)

(21) Appl. No.: 18/826,847

(22) Filed: Sep. 6, 2024

Related U.S. Application Data
(63) Continuation of application No. 17/407,491, filed on Aug. 20, 2021, now Pat. No. 12,115,803.
Application No. 17/407,491 is a continuation-in-part of application No. 17/118,217, filed on Dec. 10, 2020.

(51) Int. Cl. B41M 5/333; B41M 5/323; B41M 5/44

(52) U.S. Cl. CPC B41M 5/3333; B41M 5/323; B41M 5/44; B41M 2205/04; B41M 2205/38

(57) ABSTRACT

A recording medium comprises a substrate and a thermally responsive layer carried by the substrate. The thermally responsive layer includes a leuco dye and at least one developer. The recording medium is substantially phenol-free. The at least one developer comprises an N,N′-diphenylurea derivative selected from S-176 and TGMD.

### CROSS-REFERENCE TO RELATED APPLICATIONS

This application is a continuation of U.S. Ser. No. 17/407,491, “Fade-Resistant Water-Dispersible Phenol-Free Direct Thermal Media,” filed Aug. 20, 2021, which is a continuation-in-part of U.S. Ser. No. 17/118,217, “Multi-Purpose Phenol-Free Direct Thermal Recording Media,” filed Dec. 10, 2020, the contents of which are both incorporated herein by reference.

### FIELD OF THE INVENTION

The present invention relates to sheet-like recording materials adapted to be recorded on or printed on by conventional direct thermal recording techniques. The invention also relates to direct thermal recording media, with particular application to such media that may be substantially phenol-free while incorporating a leuco dye and an acidic developer to provide a heat-activated printing mechanism. The invention also pertains to related methods, systems, and articles.

### BACKGROUND OF THE INVENTION

In direct thermal recording, an image is produced by selectively heating the recording material (sometimes called coated thermochromic paper, thermal paper, thermal recording material or media, or thermally-responsive record material) at selected locations by passing the material under, or otherwise across, a thermal print head. The recording material includes a coating of a thermally responsive layer, and the image is provided by a heat-induced change in color of the thermally responsive layer. Some common uses of direct thermal recording may include, without limitation, cash register receipts, labels for food or other goods, or event tickets.

Numerous types of direct thermal recording media are known. See, for example, U.S. Pat. No. 3,539,375 (Baum); U.S. Pat. No. 3,674,535 (Blose et al.); U.S. Pat. No. 3,746,675 (Blose et al.); U.S. Pat. No. 4,151,748 (Baum); U.S. Pat. No. 4,181,771 (Hanson et al,); U.S. Pat. No. 4,246,318 (Baum); and U.S. Pat. No. 4,470,057 (Glanz). In these cases, basic colorless or lightly colored chromogenic material, such as a leuco dye, and an acidic color developer material are contained in a coating on a substrate which, when heated to a suitable temperature, melts or softens to permit the materials to react, thereby producing a colored mark or image at the spot where the heat is applied. Thermally-responsive record materials have characteristic thermal responses, desirably producing a colored image of sufficient intensity or contrast upon selective thermal exposure.

Depending on how such recording materials are used, they can be exposed to certain contaminants or environmental conditions. For example, direct thermal media used as labels in pharmaceutical applications may be exposed to hand sanitizing liquid. Direct thermal media used in other applications may be exposed to environmental agents or conditions peculiar to such applications, such as sweat (water), heat and/or humidity, sunlight, or meat wrapping film, to name a few. Ideally, a bar code or other image thermally printed on a direct thermal recording material should remain visible and functional when exposed to such agents. But designing such capabilities into a direct thermal product can be difficult and is not always possible or practical.

Some direct thermal recording media have been described or proposed for specialized applications in which the substrate or base material of the product is a water-dissolvable or water-dispersible paper material (in contrast with conventional paper substrates, which are neither water-dissolvable nor water-dispersible), such that the resulting direct thermal record media as a whole can be easily dissolved or dispersed by the end user. See e.g. U.S. Pat. No. 7,476,448 (Natsui et al.). Some such products have been sold, but have suffered from poor quality image formation. That is, when such products are fed through a conventional direct thermal printer to print an image at a normal print speed, such as 6 inches per section (ips), the resulting image quality is typically so poor that a bar code image cannot be reliably scanned and read by standard bar code readers. The poor image quality is believed to be due to the outer surface of the product being too rough or non-smooth, which may result from puckering or swelling of the water-dispersible base stock during manufacturing when a first layer is coated in an aqueous solution onto the surface of the base stock.

Independent of these issues, concerns were raised many years ago about the presence of phenol-based chemicals in direct thermal recording materials. Originally, phenol material was present in the thermally responsive layer of the thermal recording material, and more specifically, in the developer chemical that reacts with the leuco dye in that layer to produce a thermally-induced change of color. Alternative, phenol-free developer chemicals were developed to address these concerns. One group of such chemicals was introduced by Ciba Specialty Chemical Corp. about 20 years ago under the brand Pergafast™, including Pergafast 201 (3-(3-Tosylureido)phenyl p-toluenesulfonate). This developer is still widely used today in the manufacture of phenol-free direct thermal recording materials. Some other known phenol-free developers include NKK 1304 (N-[2-(3-Phenylureido)phenyl]benzenensulfonamide) sold by Nippon Soda Co. Ltd., Tolbutamide (1-butyl-3-(4-methylphenyl)sulfonyl urea), and Dapsone (4,4′-Diamino Diphenyl Sulfone).

### SUMMARY OF THE INVENTION

Disclosed herein are embodiments of a recording medium. A recording medium comprises a substrate and a thermally responsive layer, including a leuco dye and at least one developer, carried by the substrate. The recording medium is substantially phenol-free. The at least one developer comprises an N,N′-diphenylurea derivative selected from S0176 and TGMD.

In embodiments, the developer comprises S-176 or TGMD. In embodiments, the developer comprises S-176 and TGMD.

The substrate of a recording medium, in accordance with any of the embodiments described herein, may comprise a water-soluble paper or water-dispersible paper. A recording medium may comprise a base coat between the substrate and the thermally responsive layer. In embodiments, the base coat includes a water-soluble binder.

Disclosed herein is a recording medium comprising a substrate and a thermally responsive layer, including a leuco dye and at least one developer, carried by the substrate. The recording medium is substantially phenol-free. The at least one developer comprises an N,N′-diphenylurea derivative selected from S0176 and TGMD. A print quality of the recording medium when printed with a thermal printer energy setting of 11.7 mJ/mm² at a print speed of 6 inches per second (ips) is characterized by an ANSI value of at least 1.5. A print quality of the printed recording medium is characterized by an ANSI value of at least 1.5 even where, before the thermal printing is performed, the recording medium is exposed to air at 40° C. and 90% relative humidity for 24 hours, then removed and cooled. A print quality of the printed recording medium is still characterized by an ANSI value of at least 1.5 after the printed recording medium is exposed to air at 40° C. and 90% relative humidity for 24 hours, then removed and cooled.

In embodiments, the recording medium further comprises a top coat carried by the substrate such that the thermally responsive layer is disposed between the top coat and the substrate.

In embodiments, the thermally responsive layer has a coat weight of 2.5 to 7.5 g/m².

In some embodiments, the at least one developer comprises S-176 and a print quality of the recording medium when printed with a thermal printer energy setting of 11.7 mJ/mm² at a print speed of 6 inches per second (ips) is characterized by an ANSI value of at least 1.5. A print quality of the printed recording medium is characterized by an ANSI value of at least 1.5 even where, before the thermal printing is performed, the recording medium is exposed to air at 40° C. and 90% relative humidity for 24 hours, then removed and cooled. A print quality of the printed recording medium is still characterized by an ANSI value of at least 1.5 after the printed recording medium is exposed to air at 40° C. and 90% relative humidity for 24 hours, then removed and cooled.

In some embodiments, the at least one developer comprises TGMD and a print quality of the recording medium when printed with a thermal printer energy setting of 11.7 mJ/mm² at a print speed of 6 inches per second (ips) is characterized by an ANSI value of at least 1.5. A print quality of the printed recording medium is characterized by an ANSI value of at least 1.5 even where, before the thermal printing is performed, the recording medium is exposed to air at 40° C. and 90% relative humidity for 24 hours, then removed and cooled. A print quality of the printed recording medium is still characterized by an ANSI value of at least 1.5 after the printed recording medium is exposed to air at 40° C. and 90% relative humidity for 24 hours, then removed and cooled.

### BRIEF DESCRIPTION OF THE DRAWINGS

The inventive articles, systems, and methods are described in further detail with reference to the accompanying drawings, of which:

FIG. 1A is a schematic perspective view of a roll of direct thermal recording material or medium;

FIG. 1B is a magnified schematic front elevation view, which also serves as a schematic cross-sectional view, of such recording material; and

FIG. 2 is a schematic magnified view of a portion of a base coat used in the recording material of FIG. 1B.

In the figures, like reference numerals designate like elements.

### DETAILED DESCRIPTION OF ILLUSTRATIVE EMBODIMENTS

Aspects of the invention include new types of direct thermal record materials/media with new combinations of features and capabilities, and methods of making the same. As a direct thermal record medium, the product is adapted to change color in response to locally applied heat, such as when feeding the product through a direct thermal printer, so as to produce images of bar codes, alphanumeric characters, graphics, or combinations thereof.

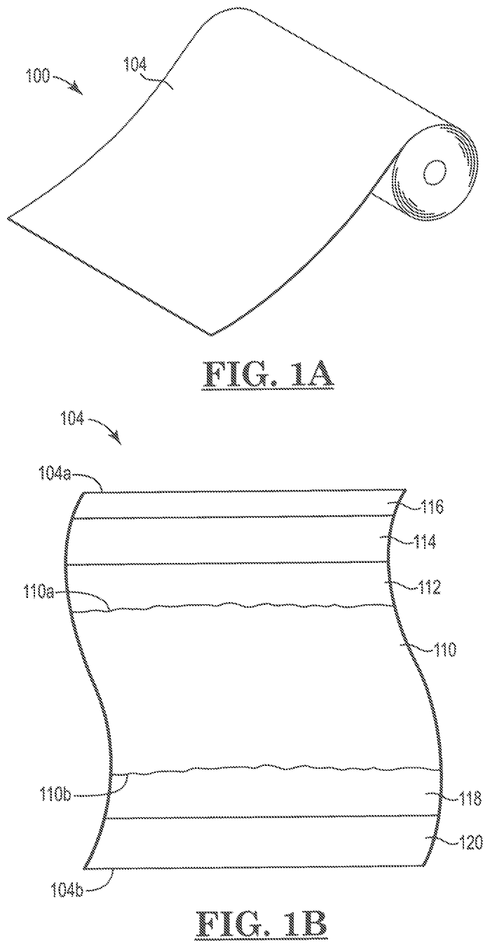

Direct thermal recording materials, including those disclosed herein, are often manufactured in large roll form, including jumbo rolls, on industrial-sized coating machines using a continuous web of paper or other flexible substrate material. Such a roll 100 of direct thermal recording material 104 is shown schematically in FIG. 1A. After manufacture, the roll 100 may be shipped to another facility or customer where the material 104 may be converted by slitting, cutting, or other standard operations into individual sheets, labels, or smaller rolls. During transit to such a facility, while in storage before such converting operations, or at some point later in the life cycle of the product, the roll 100 or a piece thereof may be exposed for long periods of time to hot, humid storage conductions such as may be found in trucks, shipping containers, or warehouses. A magnified side or cross-sectional view of the recording material 104 is shown schematically in FIG. 1B to illustrate typical sub-structure made up of component layers or coatings.

The recording material 104 may be made by applying several different coatings to at least one side or major surface 110a of a substrate 110. We may refer to the major surface 110a as the front surface of the substrate, and the exposed major surface 104a may be the front surface of the recording material 104. The opposite major surface 104b may be the back surface of the recording material. Briefly, the substrate 110 is coated to carry a base coat layer 112, a thermally responsive layer 114, and a top coat layer 116. The coatings are preferably applied in the order shown, with the layer 114 located between the layers 112, 116, and with the layer 112 located between the layer 114 and the substrate 110. In some cases, the base coat 112 may be omitted, or the top coat 116 may be omitted, or both the base coat and the top coat may be omitted. The coatings can be formed by any suitable coating technique, including roll coating, knife coating, rod coating, gravure coating, curtain coating, spot coating, and so forth. Furthermore, additional layers and coatings can be added to or included with the recording material on its front and/or back side. For example, one or more coatings can be applied to the opposite side of the substrate, i.e., to the major surface 110b, as discussed further below. But first, the other elements of the direct thermal recording material 104 will now be described in more detail.

The substrate 110 can be any material onto which the other layers can be coated or applied, and then carried. The kind or type of substrate material is not critical. Generally, the substrate 110 is in sheet or roll form, and may be or include a support member such as a web, ribbon, tape, belt, film, card, or the like. In this regard, a sheet denotes an article having two large (major) surface dimensions and a comparatively small thickness dimension, and in some cases, the sheet may be wound up to form a roll. In that regard the substrate 110 is typically thin and flexible, yet strong enough to withstand forces and tensions experienced in a coating machine, without undue breakage. The substrate 110 can be opaque, transparent, or translucent, and can be colored or uncolored. The substrate material can be fibrous including, for example, paper and filamentous synthetic materials. It can be a film including, for example, cellophane and synthetic polymeric sheets cast, extruded, or otherwise formed. Suitable plastic films include films of polypropylene (including oriented polypropylene (OPP) and biaxially oriented polypropylene (BOPP)), polyethylene (PE), and polyethylene terephthalate (PET). The substrate material can thus be non-cellulosic.

An exemplary substrate 110 may be or include a neutral sized base paper. The thickness of the substrate 110 may depend on its composition, but a typical thickness (caliper) range for cellulosic materials is from 1.9 to 12 mils (e.g. 50 to 300 μm), or other suitable thicknesses. The paper may have a basis weight in a range from 35 to 200 g/m², but other suitable basis weights may also be used. The paper may also be treated with one or more agents, such as a surface sizing agent. Uncoated base papers, including unsized, conventionally sized, and lightly treated base papers, can be used. The substrate 110 may be simple in construction and devoid of glossy coatings, or of other substantial, functional coatings. The substrate 110 may, for example, be substantially uniform in composition throughout its thickness, rather than a multilayered construction or material to which one or more separate, functional coatings have already been applied. In some cases, however, it may be desirable to treat, prepare, or otherwise work the substrate 110 in preparation for coating onto it one or more of the other layers shown in the figure.

In order to be water-dispersible (adapted to disintegrate or break apart/disperse when exposed to water, with minimal agitation), the most massive single component of the material 104—the base stock or substrate 110—should be or include a water-soluble paper or water-dispersible paper. This is in contrast to ordinary paper substrates, which are neither water-soluble nor water-dispersible. Depending on its thickness and composition, the paper of the substrate 110 may be thin and flexible similar to ordinary office paper, or it may be somewhat thicker and stiffer. We use the term “paper” to encompass all such possibilities. The substrate 110 may for example have a thickness in a range from 2.5 mils to 20 mils. The substrate 110 has a physical strength and thickness sufficient to allow it to be manipulated and handled in a coating machine without excessive tearing or breaking. The substrate 110 may thus be in the form of a web with two opposed major surfaces 110a, 110b. These surfaces are shown as being uneven or rough, which is exacerbated when the surfaces are wetted.

A suitable paper for use as the substrate 110 is Neenah Dispersa™ dispersible paper available from Neenah, Inc., Alpharettea, Ga. Pulp of which the water-dispersible paper is made need not contain large amounts of so-called purified pulp, which contains at least 88 wt % of α-cellulose, or which contains less than 12 wt % of hemi-cellulose. Such purified pulp may for example account for less than 15 wt % of all the pulp in the substrate. There are several product offerings under the Neenah™ Dispersa™ brand, including product code 7630P0 (3.0-3.4 mil thickness, said to be for labels), product code 7741P0 (14 mil thickness, said to be for tag and boardstock), and product code 7742P0 (17 mil thickness, said to be for tag and boardstock). Other water-dispersible papers suitable for use as the substrate 110 are also available. Aquasol Corporation of North Tonawanda, N.Y. sells a 3 mil thick water-dispersible flexible paper under product code ASW-35/S. SmartSolve Industries (part of CMC Group, Bowling Green, Ohio) sells a number of water-dispersible paper products, such as a 3 mil thick water-dispersible flexible paper under product code IT117970 .

Some of the commercially available water-dispersible paper of the substrate 110 may contain increased amounts of the purified pulp as disclosed in U.S. Pat. No. 8,877,678 (Koyama et al.). The purified pulp may for example account for 15-95 wt % of all the pulp in the substrate.

When one is concerned with producing a recording material that will yield direct thermal images of high enough quality to be reliably machine readable (not all manufacturers have such concerns), the water soluble/dispersible nature of the substrate 110 poses a challenge to that objective. Applying an ordinary aqueous coating to the surface of the substrate 110 can cause it to pucker or swell, which may produce a surface that is excessively rough for non-smooth such that the finished product is not capable of reliably forming a high quality direct thermal image under ordinary print conditions and print speeds. Consequently, the base coat 112, which may be applied directly to the major surface 110a, is carefully designed to avoid such problems while also allowing the overall product to be water-dispersible.

The base coat 112 may be applied directly to the surface 110a of the substrate 110 before any other coatings are applied. The base coat 112 may in some cases be characterized or described as a thermal insulating layer, a separator layer, a heat-reflective layer, an isolation layer, or a prime coat. By tailoring the layer 112 to have a thermal conductivity less than both the thermal conductivity of the thermally responsive layer 114 and the thermal conductivity of the substrate 110, the base coat 112 provides a degree of thermal insulation between those two other layers. Such thermal insulation promotes image quality, imaging speed, or both, by ensuring that heat delivered by the thermal print head (not shown) at the front surface 104a is not substantially lost by thermal conduction through the thermally responsive layer 114 to the more massive substrate 110.

The base coat 112 is specially tailored to provide a balanced combination of features. These include: having a sufficient bulk or thickness to be able to smooth over undulations or roughness of the major surface 110a of the substrate; having a sufficient air content to provide good thermal isolation (low thermal conductivity); and having an internal cohesiveness that is strong enough to remain intact during normal handling of the product but weak enough to break apart (disperse) when exposed to water after the underlying substrate 110 has dissolved, or begun to dissolve, or has dispersed, or begun to disperse.

To help achieve this combination of properties, the base coat 112 preferably uses a non-water soluble binder material. Such a binder material, when used in a judicious amount and in combination with other components of the base coat, allows the resulting record medium to be water-dispersible, i.e., it breaks apart under the influence of water with minimal agitation. The binder material of the base coat, and the base coat itself, are thus non-water-soluble, but nevertheless tailored such that the record material as a whole is water-dispersible. The binder material of the base coat is preferably a non-resinous binder, a particulate binder, and/or a binder derived from a dispersion, such as latex. Use of such a binder material in a carefully selected concentration, with other elements, provides a base coat that allows for high quality images to be thermally printed on the thermally responsive layer at normal print speeds such as 6 inches per second (ips), as well as higher print speeds.

A suitably tailored base coat 112, applied (directly) to an outer surface of the substrate 110, can substantially improve the imaging characteristics of the product, even though applying a water-based coating to the base stock increases the surface roughness. The base coat 112 is preferably neither too thin nor too thick. An insufficient coat weight produces a base coat that does not adequately insulate the thermally responsive layer 114 from the substrate, and that simply conforms to the undulating profile of the substrate. Increasing the coat weight of the base coat 112 has practical limitations because more water can cause more instability and roughening of the sheet during the coating procedure. Also, a base coat 112 that is too thick can make the internal cohesiveness of the layer too strong, thwarting the ability of the layer 112 (and the overall product 104) to break apart and disperse quickly when exposed to water. Preferably, the base coat 112 may have a thickness of at least 2 micrometers, and a coat weight in a range from 1 to 5 lbs/3300 ft² (2.5 to 7.5 g/m²), but other coat weights and thicknesses may also be used if desired.

The basecoat 112 may comprise hollow sphere pigments (HSP), such as product code Ropaque™ TH-2000 or TH-500EF available from The Dow Chemical Company, or other suitable materials. The HSP is useful in lowering the thermal conductivity of the basecoat. The basecoat 112 can be made by a process in which a dispersion is coated onto the surface 110a of the substrate, and then dried. In some cases, the basecoat 112 may be eliminated and omitted from the product construction. When included as part of the recording material, the thermal insulating layer may have a thickness in a range from 2 to 12 μm, or other suitable thicknesses.

We have also found it useful to incorporate an HSP, such as Ropaque™ pigment from Dow Chemical, into the base coat in order to increase the bulk as well as the air content of the base coat 112. The hollow polymeric particles of the HSP can improve the bulk (thickness) of the base coat to smooth over effects of the roughening of the surface of the substrate 110. A benefit of HSP is that, if the product is calendared during the manufacturing process (after the base coat has been applied to the base stock, and dried), the HSP particles can deform on the surface in contact with the calendar surface, under the pressure of the nip, to provide a smoother surface than can be made using conventional pigments. HSP particles typically have an average diameter of a few micrometers or less, e.g., in a range form 0.4 to 2 micrometers. HSP particles are not soluble in water.

Other pigments besides HSP, such as calcine clay or other clay particles, and/or other particles that have good bulk and water absorbing properties, such as precipitated calcium carbonate (PCC) or fumed silica, can also be used-and preferably are used-in the base coat 112, but do not typically by themselves provide the bulk needed to overcome the roughness of the base stock. Such other pigments are not, or may not be, soluble in water. A mixture of HSP and one or more other pigments in the base coat 112 can provide a good balance of improved coverage, smoothness, and sheet integrity, allowing for high-speed (and normal speed) direct thermal printing of machine readable bar codes.

Another significant design consideration, and aspect of the invention, is the binder material to be used in the base coat 112. Conventional wisdom would suggest that the binder material used in the base coat 112 of a water-soluble record material should be water-soluble. But we have found that water-soluble binder materials tend to increase the thermal conductivity, and reduce the thermal insulation characteristic, of the base coat. Reduced thermal insulation degrades the image quality, since the print quality of a direct thermal image is enhanced by thermally isolating the direct thermal layer from the base stock as much as possible. In contrast, our preferred binder materials-which are not water soluble-provide a quick-drying solution, and if used at a carefully tuned concentration, provide improved thermal insulation properties over the water-soluble binders while not impeding the water-dispersible nature of the substrate. Preferred binder materials for the base coat 112 include those that are non-water-soluble, those that are non-resinous, those that are a particulate binder, and/or those that are derived from a dispersion. An exemplary such binder material is latex. Alternative or additional binder materials may include cooked starch, polyvinyl alcohol (PVA), and AQ™ polymers available from the Eastman Chemical Company.

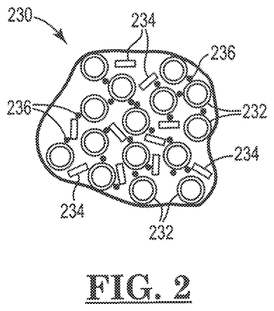

Carefully tuning this binder concentration balances the need to hold the pigment particles together in order to withstand normal handling of the material 104, with the need to provide an abundant number of air pockets and air gaps throughout the base coat 112 in order to increase thermal insulation, as well as with the need to provide a relatively weak internal cohesiveness of the base coat so that it readily breaks apart when the underlying substrate 110 begins to disintegrate or dissolve under the action of water. A schematic depiction of such a balanced or tuned state of affairs is shown in the magnified view of FIG. 2. There, a representative but small portion 230 of a base coat 112 is made up of HSP particles 232, particles 234 of a second pigment such as calcine clay, and binder particles 236 such as latex. The binder particles 236 are numerous enough to adequately hold the pigment particles together, but sparse enough to maintain an abundant number of air pockets and air gaps between the particles for adequate thermal insulation.

To provide the desired balance of characteristics, the latex or other suitable non-water-soluble binder is preferably present in the base coat 112 in a concentration from 10-30 wt %, or from 15-20 wt %. The HSP is preferably present in the base coat 112 in a concentration from 20-50 wt %, or from 30-50 wt %. The calcine clay or other suitable second pigment is preferably present in the base coat in a concentration less than 80 wt %, or in a range from 10-50 wt %.

The thermally responsive layer 114 may be coated atop the basecoat 112, or atop the substrate 110 if the basecoat is omitted. The layer 114 may alternatively be referred to as a heat-sensitive color-forming layer. This layer 114 comprises a color-forming composition that is thermally sensitive, i.e., it changes color upon sufficient heating. The color-forming composition has two main components: a color-forming dye (electron-donating dye precursor), also known as a leuco dye or chromogenic material, and an acidic developer. The leuco dye and acidic developer are typically ground to individual particle sizes of between 1 to 10 micrometers, dispersed in a solid matrix or binder, and distributed homogeneously and in a contiguous relationship with each other throughout the layer 114. Sufficient heating at any position allows the particles of acidic developer to react with the particles of leuco dye which results in a color change at the site of the heating, usually from light to dark. Known systems and materials are described in U.S. Pat. No. 3,539,375 (Baum), U.S. Pat. No. 3,674,535 (Blose et al.), U.S. Pat. No. 3,746,675 (Blose et al.), U.S. Pat. No. 4,151,748 (Baum), U.S. Pat. No. 4,181,771 (Hanson et al.), U.S. Pat. No. 4,246,318 (Baum), U.S. Pat. No. 4,470,057 (Glanz), and U.S. Pat. No. 5,955,398 (Fisher et al.).

Leuco dyes are generally not phenol-based, and we have found that the types of problems discussed herein are not substantially affected by the selection of leuco dye used in the layer 114. Thus, substantially any leuco dye may be used.

The acidic developer is preferably non-phenolic, and, as already explained above, advantageously includes a combination of two distinct non-phenolic developer materials, in particular, 1,3-diphenyl urea (“DPU”), and urea urethane (“UU”). DPU may alternatively be referred by names such as: 1-3-Diphenylurea or 1-3-diphenylurea; N,N′-Diphenylurea; Diphenylurea; Urea, N,N′-diphenyl-; CARBANILIDE; Diphenylcarbamide; or C₁₃H₁₂N₂O. UU may alternatively be referred by names such as: urethane urea; urethane-urea copolymer; polyurethane urea, or poly(urethane urea); polyurethane urea elastomer, or poly(urethane urea) elastomer; polyurea-urethane; poly(urea) urethane; poly(urea-urethane) polymer; poly(urea-urethane) thermoset; poly(ether urethane urea); poly(ester urethane urea); poly(ester urethane) urea elastomer; or C₄H₁₁N₃O₃.

One rationale for using developers that are non-phenolic in the thermally responsive layer 114 is to satisfy the market demand for phenol-free receipts, labels, and the like. As such, it is desirable in many cases, but not necessary in all cases, for not only the thermally responsive layer 114 to be phenol-free or substantially phenol-free, but for the entire direct thermal recording material 104 to be phenol-free or substantially phenol-free. We use the term substantially phenol-free to include both items that are absolutely and completely phenol-free, as well as items that may have only trace amounts of phenolic materials below thresholds.

We discovered that some phenol-free developer materials, including the most widely used phenol-free developer, can give rise to long-term image fade or image formation problems. These problems may be easily overlooked by the product designer, since direct thermal recording products incorporating those chemicals can provide fully acceptable direct thermal images as long as the product is not subjected to the types of hot, humid storage conditions described herein.

The image fade and image formation problems associated with hot, humid storage conditions, and developers that can be used to avoid such problems, are demonstrated in the testing results below. Briefly summarized, the developer used in the thermally responsive layer 114 of the recording material 104 is preferably a derivative of N,N′-diphenylurea. Exemplary such materials include:

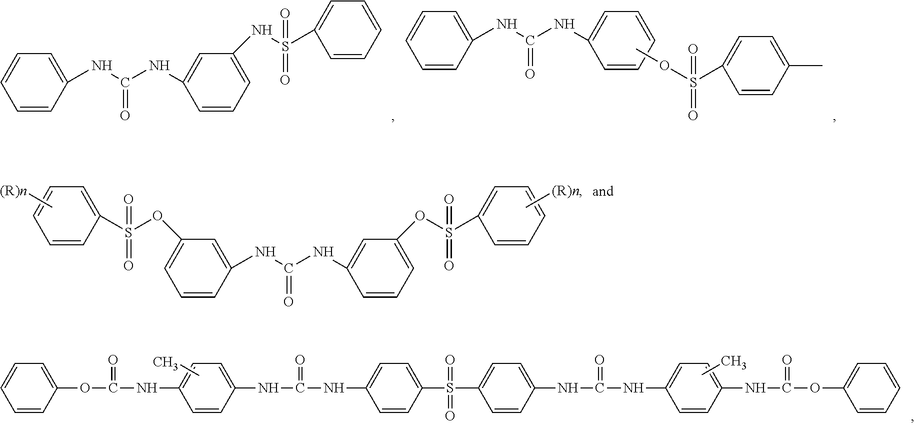

which we may refer to for convenience by their respective trade names or chemical names NKK-1304 (Nippon Soda Ct., Ltd.), TGMD (Nippon Kayaku Co. Ltd.), S-176 (Sanko Co. Ltd.), and urea urethane (“UU”).

Among this list of exemplary chemicals, urea urethane (“UU”) is a special case because if it is used by itself as the only developer in the layer 114, the image produced by the direct thermal recording material 104 (if printed under standard conditions, with a thermal printer energy setting of 11.7 mJ/mm² at a print speed of 6 inches per second) is substandard and unacceptable, characterized by a very faint image having an ANSI value of well under 1.5. On the other hand, the use of 1,3 diphenyl urea (“DPU”, which is phenol-free but for purposes of this document is not in itself considered to be a derivative of N,N′-diphenyl urea) by itself as the only developer in the layer 114 is also unacceptable, but for a different reason: although the thermal image printed under standard conditions typically has fully adequate darkness/contrast/visibility, and an ANSI value above 1.5, it exhibits substantial image fad whereby the ANSI value drops below 1.5.

That is, neither DPU nor UU is particularly noteworthy by itself when used with a suitable leuco dye. In fact, when UU is used with no other developer materials but with a suitable leuco dye in a thermally responsive layer, the resulting direct thermal recording material, when imaged by a direct thermal printer, produces an initial image that doesn't even meet the minimum requirement for bar code machine-readability. On the other hand when the UU in such a product is entirely replaced by DPU, i.e. when the DPU is used by itself as the only developer in the layer 114, the image initially produced by the direct thermal printer does meet the minimum requirement for bar code machine-readability, but no longer does so after the printed sample is subjected to any one of a number of environmental exposure tests as explained further below. Surprisingly, when DPU and UU are used in combination, dispersed together throughout the layer 114 along with a suitable leuco dye, the resulting product not only provides a thermally produced image that meets the minimum requirement for bar code machine-readability, but also maintains that image quality after the printed sample is subjected to environmental exposure tests that are not passed by otherwise identical recording materials containing only DPU or only UU as the developer. That is, the resulting product provides a thermal image that is somewhat fainter and not as dark as a “DPU only” counterpart (but whose ANSI value is still acceptable 1.5 or greater), but unpredictably and unexpectedly, the visibility of the image has good persistence, and does not suffer from the image fade problems of the “DPU only” counterpart.

For purposes of this document, “DPU” may alternatively be referred to as: 1-3-diphenylurea; N,N′-diphenylurea; diphenylurea; urea, N,N′-diphenyl-; CARBANILDE; or diphenylcarbamide. UU may alternatively be referred to by names such as urethane urea; urethane-urea copolymer; polyurethane urea; poly(urethane urea); polyurethane urea elastomer; poly(urethane urea) elastomer; polyurea-urethane; poly(urea) urethane; poly(urea-urethane) polymer; poly(urea-urethane) thermoset; poly(ether urethane urea); poly(ester urethane urea); or poly(ester urethane) urea elastomer.

In embodiments that use the combination of DPU and UU, the DPU, the UU, and the selected leuco dye are each preferably dispersed homogeneously and evenly throughout the thermally responsive layer 114. This does not necessarily mean that these various materials have equal loadings in that layer. In most cases, however, we have found it desirable to have roughly equal loadings of the DPU and UU, i.e., a relative weight ratio of DPU/UU of roughly 1. But other weight ratios of DPU/UU can also be used as demonstrated in the examples below. The DPU/UU weight ratio may for example fall within a range from ⅓ to 3, or from ½ to 2, or it may be about 1. When the DPU and UU are used in combination, they are preferably the only chemical developers used in the layer 114. However, if desired, one or more other chemical developers may also be added besides the DPU and UU. If this is done, such other developer(s) are preferably individually and collectively present in the layer 114 in a weight percentage lower than that of DPU, and lower than that of UU.

The examples below demonstrate that the other non-phenolic developers that are derivatives of N,N′-diphenylurea, including NKK-1304, TGMD and S-176, can be used with success as the only developer in the layer 114, producing clear thermal images when printed under standard direct thermal printing conditions. Alternatively, if desired, these developers can be used in combination with each other, or with other non-phenolic developers, in the layer 114. Other than cases involving the combination of DPU and UU, the layer 114 is preferably substantially devoid of any developers that are not derivatives of N,N′-diphenylurea.

Besides the DPU and UU, the thermally responsive layer 114 also of course includes at least one leuco dye tailored to react with the plurality of developers at elevated temperatures to produce a mark or color change. The leuco dye, or dyes, may be any known dye(s) capable of such a reaction. Examples include, without limitation:
ODB-2 (CAS no. 89331-94-2, chemical name spiro (isobenzofuran-1(3H),9′-(9H)xanthen)-3-one, 6′-(ethyl(4-methylphenyl)amino)-3′-methyl-2′-(phenylamino)-);
BK305 (CAS no. 129473-78-5, chemical name spiro (isobenzofuran-1(3H),9′-(9H)xanthen-3-one, 6′-(dipentylamino)-3′-methyl-2′-(phenylamino)-); and
ETAC (CAS no. 59129-79-2, chemical name spiro (isobenzofuran-1(3H),9′-(9H)xanthen)-3-one, 6′-(ethyl(4-methylphenyl)amino)-3′-methyl-2′-(phenylamino)-).

The thermally responsive layer 114 also includes one or more suitable binders to help hold the particles in the layer together. Such binders may include poly(vinylalcohol), hydroxy ethylcellulose, methylcellulose, isopropyl cellulose, starch, modified starches, gelatin, and the like. Latex materials including polyacrylates, polyvinylacetates, polystyrene, and the like, may also be used. The binder helps maintain the mechanical integrity of the layer 114 in response to brushing or handling forces resulting from use or storage of the recording material 104. Enough of the binder should be present to provide such protection, but not so much so as to interfere with achieving reactive contact between the color-forming reactive materials. The binder may be present at 5 to 30 wt % of the dried coating.

In addition to the leuco dye, the developers, and the binder, the color-forming composition of the layer 114 may also contain one or more materials referred to as modifiers, which aid in color formation. The modifier(s) can function by one or both of (a) lowering the melting point of the dye/developer, and (b) acting as a type of solvent in which the dye and developer dissolve or melt. The modifier(s) may thus facilitate the reaction between the leuco dye and the developer to produce a more intense thermal image, faster imaging, or both. See, for example, U.S. Pat. No. 4,531,140 (Suzuki et al.), U.S. Pat. No. 4,794,102 (Petersen et al.), U.S. Pat. No. 5,098,882 (Teraji et al.), U.S. Pat. No. 6,835,691 (Mathiaparanam et al.), and U.S. Pat. No. 6,921,740 (Hizatate et al.).

Ordinarily, the thermally responsive layer of a conventional direct thermal recording material would be applied in a thickness corresponding to a coat weight from 1.5 to 6 pounds/3,300 ft² (2.2 to 8.9 g/m²), or more typically from 2-4 pounds/3,300 ft² (3.0 to 5.9 g/m²), for a finished dry thickness in a range from 1.2 to 4.8 μm, or from 1 to 5 μm. A practical lower limit has been a coat weight of about 1 pound/33,000ft² (˜1.48 g/m²). The thermally responsive layer 114 of the inventive recording material 104 may also if desired be applied in these same conventional coat weights and thicknesses, but we have found that another benefit of the disclosed combination of developers DPU/UU is that the layer 114 can be made much thinner while still providing acceptable thermal image quality. In particular, the layer 114 can be made with a coat weight of less than 1 pound/3,300 ft² (1.48 g/m²). We have demonstrated acceptable product performance with the coat weight of the layer 114 (containing DPU and UU developers) as low as 0.9 g/m². The coat weight of the layer 114 may thus be in a range from, for example, 0.9 to 8.9 g/m², or 0.9 to 5.9 g/m², or 0.9 to 2.2 g/m², or 0.9 to 1.48 g/m², or 0.9 up to, but less than, 1.48 g/m².

The ability to make the thermally responsive layer 114 ultra-thin has a number of benefits such as lower product weight/mass, lower product cost, and reduced environmental impact in terms of the post-use waste stream.

Turning again to FIG. 2, a topcoat layer 116 is shown atop, in contact with, the thermally responsive layer 114. In the embodiment illustrated, the outer major surface of the topcoat 116 is exposed to air and corresponds to the outer major surface 104a of the direct thermal recording material 104. The topcoat 116 is optional and can be omitted if desired. If it is included, it can protect underlying layers of the recording material 104 from unwanted contaminants or substances. For example, some topcoats can be used as barriers or seals against seepage by oils or other unwanted liquids.

The topcoat 116 may be any suitable topcoat of conventional design. The topcoat 116 may for example comprise binders such as modified or unmodified polyvinyl alcohols, acrylic binders, crosslinkers, lubricants, and fillers such as aluminum trihydrate and/or silicas. The topcoat 116 may have a thickness in a range from 0.5 to 2 μm, or other suitable thicknesses.

The disclosed recording materials may also include additional layers and coatings other than those discussed above. Such other layers or coatings include coating(s) that can be applied to the back surface 110b of the substrate 110. One such layer is illustrated in FIG. 2, labeled 118. This layer 118 may be an adhesive layer comprising a pressure sensitive adhesive (PSA), hot melt adhesive, or other suitable adhesive. By providing it on the back side of the recording material 104, the recording material can serve as a label and can attach to containers, films, or other bodies while having its front, thermally printed side visible to users. Such an adhesive is preferably itself water-dispersible or water-dissolvable so that after use, the entire label can be easily washed away and completely removed from the workpieces to which it was attached by the user, e.g., after direct thermal printing. The adhesive may be releasably carried by an optional release liner 120. A release liner (not shown) can also be included to cover a PSA layer until ready for use. Release coatings may also be applied to the surface for applications that do not require a liner.

In the case of a label product, a user may remove the release liner 120 after forming a thermal image in the direct thermal layer 114, and affix the label so printed to a container or other suitable workpiece with the adhesive layer 118. After use, the label may be completely removed from the container by applying water with minimal or gentle agitation, causing the label to break apart to restore the container surface to its original state.

Direct thermal recording materials can potentially be used in a variety of settings and, as such, can be exposed to a wide variety of environmental agents, contaminants, and conditions. Images formed by direct thermal printing on such materials are known to be subject to degradation when exposed to at least some of those conditions. A given recording material may experience degradation to more or fewer of these conditions depending on its details of construction, including the chemicals used in the thermally responsive layer. Of course, the more environmental conditions the recording material can withstand without substantial degradation of the image, the more settings and applications it can be used in.

Dry heat: one environmental condition of interest is exposure of the imaged material to heat, i.e., heat stability. Of course, if an imaged recording material is heated to a high enough temperature, e.g. approaching a print head temperature of at least about 200° C., the leuco dye will react with the developer throughout the entire thermally responsive layer, causing the entire front surface of the recording material to change color and obliterating any image that was previously formed thereon. Here we are instead concerned with a heated environment substantially above ambient room temperature but in the neighborhood of 60° C., which an imaged recording material may experience if attached as a label to a cup or container of coffee or other hot beverage, or if attached to the package of a food item meant to be heated or cooked in a microwave oven.

Plasticizer: another environmental condition of interest is contact with a plasticized film, especially polyvinyl chloride (PVC) film used to wrap meat in grocery stores. Direct thermal recording materials can be used as labels applied to such packaged meat. The direct thermal image printed on the front of the label can come into contact with PVC film from other packages.

Water: another environmental condition of interest is immersion in water. This may happen if a printed receipt or ticket is left in a pocket of clothing and inadvertently sent through the cycle of a washing machine. The most benign version of this environmental condition is where the water is at room temperature, or possibly tepid.

Boiling water: this environmental condition of interest is like the water immersion condition, but where the water is at the boiling temperature.

Sultry: another sultry environmental condition of interest is exposure to hot, humid conditions as may be experienced in tropical areas. This may for example involve temperatures around 40° C. and a relative humidity of 90%.

Sunlight: another environmental condition of interest is exposure to sunlight.

Sanitizer: another environmental condition of interest is contact with alcohol-based hand sanitizer fluids.

### EXAMPLES and COMPARATIVE EXAMPLES

### Part A:

In accordance with the foregoing teachings, a number of direct thermal recording media examples and comparative examples were fabricated and tested.

In preparation for making the samples, a number of dispersion formulations were prepared. These were of two types: dispersion formulations for leuco dyes, and dispersion formulations for acidic developers. The formulations for the leuco dyes followed a first recipe, “A”, and formulations for the developers followed a second recipe, “B”, as follows, where all parts or percentages are understood to be parts per weight:

TABLE 1
Dispersion A Formulation

| Material | Parts |
|---|---|
| chromogenic material (leuco dye) | 30.0 |
| binder, 20% solution of polyvinyl alcohol in water | 25.0 |
| defoaming and dispersing agents | 0.4 |
| water | 44.6 |

TABLE 2
Dispersion B Formulation

| Material | Parts |
|---|---|
| developer material | 38.0 |
| binder, 20% solution of polyvinyl alcohol in water | 18.0 |
| defoaming and dispersing agents | 0.4 |
| water | 43.6 |

A formulation referred to as Dispersion A1 followed recipe “A” and used ODB-2, i.e., 2-anilino-3-methyl-6-dibutylaminofluoran, as the chromogenic material.

A formulation referred to as Dispersion A2 followed recipe “A” and used BK-305, i.e., 2-anilino-3-methyl-6-dipentylaminofluoran, as the chromogenic material.

A formulation referred to as Dispersion B1 followed recipe “B” and used DPU, i.e., 1,3-Diphenyl Urea, as the developer material.

A formulation referred to as Dispersion B2 followed recipe “B” and used UU, i.e., urethane urea (in particular Urea Urethane Compound sold by Chemipro Kasei Kaisha Ltd., CAS No. 321860-75-7), as the developer material.

A formulation referred to as Dispersion B3 followed recipe “B” and used D-8, i.e., 4-Hydroxyphenyl-4-isopropoxyphenylsulfone, as the developer material.

A formulation referred to as Dispersion B4 followed recipe “B” and used BPS, i.e., 4-Hydroxyphenyl sulfone, as the developer material.

A formulation referred to as Dispersion B5 followed recipe “B” and used BPS-MBE, i.e., 4-Benzyloxyphenyl-4′-hydroxyphenyl sulfone, as the developer material.

A formulation referred to as Dispersion B6 followed recipe “B” and used Tolbutamide, i.e., 1-butyl-3-(4-methyl phenyl) sulfonyl urea, as the developer material.

A formulation referred to as Dispersion B7 followed recipe “B” and used Dapsone, i.e., 4,4′-Diamino Diphenyl Sulfone, as the developer material.

A formulation referred to as Dispersion B8 followed recipe “B” and used Pergafast™ 201, i.e., N-(p-Toluenesulfonyl)-N′-(3-p-toluenesulfonyloxyphenyl) urea, sold by Solenis LLC, as the developer material.

A formulation referred to as Dispersion B9 followed recipe “B” and used NKK-1304, i.e., N-[2-(3-Phenylureido)phenyl]benzenensulfonamide, sold by Nippon Soda Co. Ltd., as the developer material.

Different ones of these dispersion formulations were mixed together with other ingredients to create a coating formulation for use in forming the thermally responsive layer of a given sample. The coating formulation was as follows unless otherwise indicated:

TABLE 3
Coating Formulation for Thermally Responsive Layer

| Material | Parts |
|---|---|
| Dispersion A (chromogenic material/leuco dye) | 22.0 |
| Dispersion B (developer) | 38.0 |
| binder, 10% solution of polyvinyl alcohol in water | 25.0 |
| Filler slurry, 30% in water | 15.0 |

Each sample (example or comparative example) was made in the following manner unless otherwise indicated. The first step was to coat a basecoat (see e.g. layer 112 in FIG. 2) onto one side or major surface of a substrate (see e.g. substrate 110 in FIG. 2). The substrate used was a 63 g/m² (gsm) highly refined paper sheet. The basecoat was thermally insulating and comprised a mixture of calcined clay such as Ansilex 93 by BASF Corporation, and Ropaque™ TH-2000 hollow sphere pigment (HSP) by The Dow Chemical Company, along with an SBR binder, and was applied at a coat weight of 4.5 g/m². After drying, a thermally-responsive layer (see e.g. layer 114 in FIG. 2) was coated atop the basecoat. The coat weight of the thermally-responsive layer was 1.3 g/m² unless otherwise indicated. After this coating was dry, a topcoat (see e.g. topcoat 116 in FIG. 2) was coated onto the surface of the thermally-responsive layer.

The topcoat was composed of delaminated clay, PVOH, crosslinker, and lubricant such as zinc stearate, and was applied at a coat weight of 1.5 g/m². After the topcoat was dry, no other coatings were applied to the sample, and the sample was ready for thermal printing and testing.

The following table shows the names given to the various samples (Examples 1 through 6 and Comparative Examples 1 through 12) that were made and tested, and the details of their respective thermally responsive layers:

TABLE 4
Sample Names and Details Regarding Thermally Responsive Layer

| Sample | Dispersion A | Dispersion B | | |
|---|---|---|---|---|
| name | (leuco dye) | (developer) | Comment re Dispersion B | coat weight |
| Ex 1 | A1 | B1 and B2 | 1:1 ratio, B1 and B2 at 19 parts each | 1.3 |
| Ex 2 | A2 | B1 and B2 | 1:1 ratio, B1 and B2 at 19 parts each | 1.3 |
| Ex 3 | A2 | B1 and B2 | 1:3 ratio, B1 at 9.5, B2 at 28.5 parts | 1.3 |
| Ex 4 | A2 | B1 and B2 | 3:1 ratio, B1 at 28.5, B2 at 9.5 parts | 1.3 |
| Ex 5 | A1 | B1 and B2 | 1:1 ratio, B1 and B2 at 19 parts each | 1.1 |
| Ex 6 | A1 | B1 and B2 | 1:1 ratio, B1 and B2 at 19 parts each | 0.9 |
| CE1 | A1 | B1 | | 1.3 |
| CE2 | A1 | B2 | | 1.3 |
| CE3 | A2 | B1 | | 1.3 |
| CE4 | A2 | B2 | | 1.3 |
| CE5 | A1 | B3 | | 1.3 |
| CE6 | A1 | B4 | | 1.3 |
| CE7 | A1 | B5 | | 1.3 |
| CE8 | A1 | B8 | | 1.3 |
| CE9 | A1 | B9 | | 1.3 |
| CE10 | A1 | B6 and B7 | 1:1 ratio, B6 and B7 at 19 parts each | 1.3 |
| CE11 | A1 | B1 and B8 | 1:1 ratio, B1 and B8 at 19 parts each | 1.3 |
| CE12 | A1 | B1 and B9 | 1:1 ratio, B1 and B9 at 19 parts each | 1.3 |

All of these samples were thin and flexible, phenol-free, and their front surfaces were uniformly white or light in color. Each sample was then tested for its ability to form an image by direct thermal printing, the print quality of that image, and the print quality of the image after subjecting the printed sample to a number of different environmental tests.

The thermal printing was performed on each sample using a Zebra™ thermal printer, model 140-401, at a speed of 6 inches per second (ips) and using the default energy setting of the print head, which was 11.7 mJ/mm². The printed image was in each case a barcode pattern. The print quality or image quality of the barcode pattern was evaluated using a TruCheck™ barcode verifier (model TC-843) operating at a wavelength of 650 nm, a passing result corresponding to an ANSI value of 1.5 or more, and a failing result corresponding to an ANSI value of less than 1.5. In some cases, the print quality of the same image was also evaluated at 670 nm using a TruCheck™ barcode verifier model TC-854, where again a passing score corresponded to an ANSI value of 1.5 or more, and a failing score corresponded to an ANSI value of less than 1.5.

After the initial print quality of the printed recording medium was measured, a specimen of each sample was subjected to each of the seven environmental tests outlined above, namely: dry heat; plasticizer; water; boiling water; sultry; sunlight; and sanitizer.

For the dry heat test, the printed specimen was exposed to 60° C. (dry) heat for 24 hours, then removed from the heat. After this test the quality of the printed image was tested at both 650 nm and 670 nm.

For the plasticizer test, the printed specimen was dipped in room temperature water, then removed and placed in contact with a polyvinyl chloride meat wrapping film under a 7 pound weight for 24 hours, then removed and allowed to dry. After this test the quality of the printed image was tested at 650 nm.

For the water test, the printed specimen was soaked in room temperature water for 24 hours, then removed and allowed to dry. After this test the quality of the printed image was tested at 650 nm.

For the boiling water test, the printed specimen was adhered to a plastic swatch and submerged in boiling water for 20 minutes, then removed and allowed to dry. After this test the quality of the printed image was tested at 650 nm.

For the sultry test, the printed specimen was exposed to 40° C. heat and 90% relative humidity for 24 hours. After this test the quality of the printed image was tested at both 650 nm and 670 nm.

For the sunlight test, the printed specimen was placed into an accelerated sunlight test chamber (Q-Sun™ Xenon test chamber, sold by Q-Lab Corporation, Westlake, OH) at an irradiance of 0.67 W/m² for 7 hours, then removed. After this test the quality of the printed image was tested at both 650 nm and 670 nm.

For the sanitizer test, one drop of Purell™ hand sanitizer, sold by Gojo Industries, was placed on the printed specimen and allowed to dry. After this test the quality of the printed image was tested at both 650 nm and 670 nm.

The results of some of these sample runs, the initial print quality test, and the print quality tests after each of the above-described environmental tests, are reported in Table 5:

TABLE 5

| | | | | ANSI test results onorinted barcode image | | | | | | | |
|---|---|---|---|---|---|---|---|---|---|---|---|
| | | | | | | wet | hot | | 40/90 | Sun- | sani- |
| Example | dye | Developer | ctwt | initial | water | pvc | water | heat | RH | light | tizer |
| CE1 | ODB2 | DPU | 1.3 | pass | pass | fail | fail | fail | fail | pass | fail |
| CE2 | ODB2 | UU | 1.3 | fail | fail | fail | fail | fail | fail | fail | fail |
| CE3 | BK305 | DPU | 1.3 | pass | pass | fail | fail | fail | fail | pass | fail |
| CE4 | BK305 | UU | 1.3 | fail | fail | fail | fail | fail | fail | fail | fail |
| Ex 1 | ODB2 | 1:1 | 1.3 | pass | pass | pass | pass | pass | pass | pass | pass |
| | | DPU/UU | | | | | | | | | |
| Ex 2 | BK305 | 1:1 | 1.3 | pass | pass | pass | pass | pass | pass | pass | pass |
| | | DPU/UU | | | | | | | | | |
| Ex 3 | BK305 | 1:3 | 1.3 | pass | pass | pass | fail | pass | pass* | pass* | pass* |
| | | DPU/UU | | | | | | | | | |
| Ex 4 | BK305 | 3:1 | 1.3 | pass | pass | fail | fail | pass | pass* | pass | fail |
| | | DPU/UU | | | | | | | | | |
| Ex 5 | ODB2 | 1:1 | 1.1 | pass | pass | pass | pass | pass | pass | pass | pass |
| | | DPU/UU | | | | | | | | | |
| Ex 6 | ODB2 | 1:1 | 0.9 | pass | pass | pass | fail | pass | pass | pass | fail |
| | | DPU/UU | | | | | | | | | |

In this table, a “pass” result refers to an ANSI value at 650 nm (and at 670 nm where applicable) of at least 1.5; a “pass*” result refers to an ANSI value at 650 nm of at least 1.5 but an ANSI value at 670 nm below 1.5; and a “fail” result refers to an ANSI value at 650 nm (and at 670 nm where applicable) of less than 1.5.

A comparison of Comparative Examples 1-4 with Examples 1-6 in the table demonstrate that the new developer chemistry combination of DPU and UU can produce a multi-purpose direct thermal recording material capable of passing a plurality of environmental exposure tests, but when used individually in an otherwise identical thermal recording material, cannot pass those same environmental exposure tests. The comparative examples that use UU by itself yield direct thermal recording materials which produce an image that does not meet even the minimum standard for machine-readability for bar codes.

The results of Table 5 demonstrate that the relative weight ratio of DPU to UU in the thermally responsive layer need not be 1 but can range at least from ⅓ to 3, as well as narrower ranges such as ½ to 2. The results of Table 5 further demonstrate that the coat weight of the thermally responsive layer, when DPU and UU are used in combination, can be as low as 0.9 g/m² and still produce direct thermal images with acceptable print quality.

The results of the remaining comparative examples are shown in Table 6, where “pass”, “pass*”, and “fail” have the same meanings as in Table 5:

TABLE 6

| | | | | ANSI test results on printed barcode image | | | | | | | |
|---|---|---|---|---|---|---|---|---|---|---|---|
| | | | | | | wet | hot | | 40/90 | Sun- | sani- |
| Example | dye | developer | ctwt | initial | water | pvc | water | heat | RH | light | tizer |
| CE5 | ODB2 | D-8 | 1.3 | pass | pass | fail | fail | pass | pass | pass | fail |
| CE6 | ODB2 | BPS | 1.3 | pass | pass | fail | fail | pass | pass | pass | fail |
| CE7 | ODB2 | BPS-MBE | 1.3 | pass | pass | fail | fail | pass | pass | pass* | fail |
| CE8 | ODB2 | Perg | 1.3 | pass | pass | fail | fail | pass | pass | pass* | fail |
| CE9 | ODB2 | NKK | 1.3 | pass | pass | fail | fail | pass | pass | pass | fail |
| CE10 | ODB2 | 1:1 | 1.3 | fail | fail | fail | fail | fail | fail | fail | fail |
| | | Tol/Daps | | | | | | | | | |
| CE11 | ODB2 | 1:1 | 1.3 | pass | pass | fail | fail | pass | fail | pass | fail |
| | | DPU/Perg | | | | | | | | | |
| CE12 | ODB2 | 1:1 | 1.3 | pass | pass | fail | fail | pass | pass | pass | fail |
| | | DPU:NKK | | | | | | | | | |

### Part B:

Example 1: A record material as shown generally in FIG. 1B, but without layers 118 and 120, was made and tested. The substrate 110 used was the Neenah Dispersa™ dispersible paper, product code 7630P0, referenced above. A base coat 112 was then applied to the major surface 110a at a coat weight of 6 grams per square meter (gsm). The formulation of the base coat was as follows (all parts are by weight unless otherwise noted):
Water: 40.5 parts
Mineral Pigment 1A: 21.5 parts
HSP @ 19.5% solids in water: 26.3 parts
Latex @ 50% solids in water: 11.5 parts
   The Mineral Pigment 1A was Calcine Clay (Kaocal by Thiele Kaolin Company). The HSP used was Ropaque TH-2000AF by Dow Chemical, having an average diameter of nominally 1.6 micrometers. The Latex used was SBR latex (LIGOS KX4505 by Trinseo LLC.).

After drying, a thermally responsive layer 114 was applied to the exposed surface of the base coat. The layer was made using a coating formulation as follows:
Dispersion A (leuco dye): 22.0 parts
Dispersion B (developer): 38.0 parts
Binder, 10% solution of polyvinylalcohol in water: 25.0 parts
Filler slurry, 30% in water: 15.0 parts,
   where Dispersion A (comprising the leuco dye or chromogenic material) was:
ODB-2 (2-anilino-3-methyl-6-dibutylaminofluoran): 30.0 parts
Binder, 20% solution of polyvinylalcohol in water): 25.0 parts
Defoaming and dispersing agents: 0.4 parts
Water: 44.6 parts,
   and Dispersion B (comprising the developer) was:
NKK-1304 (from Nippon Soda Ct., Ltd.): 38.0 parts
Binder, 20% solution of polyvinylalcohol in water: 18.0 parts
Defoaming and dispersing agents: 0.4 parts
Water: 43.6 parts.
   The chemical formula for NKK-1304 is given above. This formulation was applied to the base coat at a coat weight of 2.0 gsm to form the thermally responsive layer 114.

After drying, a top coat 116 was applied to the exposed surface of the thermally responsive layer. This layer was made using a coating formulation as follows:
Filler slurry, 30% aluminum hydroxide in water: 23.0 parts
Aqueous solution of polyvinyl alcohol in an amount of 10%: 63.0 parts
Zinc state in an amount of 44% in water: 1.0 parts
Crosslinker, 12.5% in water: 13.0 parts
   This formulation was applied to the thermally responsive layer at a coat weight of 1.5 gsm to form the top coat 116.

Example 1-SS: A record material was made in the same manner as Example 1, except that a SmartSolve™ 3 point (“3 pt”) water-dispersible (“water-soluble”) paper from SmartSolve Industries was used as the substrate instead of the Neenah Dispersa™ dispersible paper.

Example 2: A record material was made in the same manner as Example 1, except that in the Dispersion B, the developer TGMD (from Nippon Kayaku Co. Ltd.) was used instead of NKK-1304. The chemical formula for TGMD is given above.

Example 2-SS: A record material was made in the same manner as Example 2, except that the 3 pt. SmartSolve™ dispersible paper referenced above was used as the substrate instead of the Neenah Dispersa™ dispersible paper.

Example 3: A record material was made in the same manner as Example 1, except that in the Dispersion B, the developer S-176 (from Sanko Co. Ltd.) was used instead of NKK-1304. The chemical formula for S-176 is given above.

Example 3-SS: A record material was made in the same manner as Example 3, except that the 3 pt. SmartSolve™ dispersible paper referenced above was used as the substrate instead of the Neenah Dispersa™ dispersible paper.

Example 4: A record material was made in the same manner as Example 1, except that in the Dispersion B, the NKK-1304 was replaced by a 50/50 solution of UU (from Chemipro Kasei Kaisha Ltd.) and DPU. The chemical formulae for UU and DPU are given above.

Comparative Example 5: A record material was made in the same manner as Example 1, except that in the Dispersion B, the developer NKK-1304 was replaced by 4-Hydroxyphenyl-4-isopropoxyphenylsulfone (trade name “D-8”), which is represented by the formula:

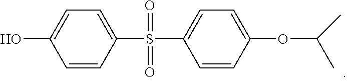 [SMILES: CC(C)Oc1ccc(S(=O)(=O)c2ccc(O)cc2)cc1]

Comparative Example 5-SS: A record material was made in the same manner as Comparative Example 5, except that the 3 pt. SmartSolve™ dispersible paper referenced above was used as the substrate instead of the Neenah Dispersa™ dispersible paper.

Comparative Example 6: A record material was made in the same manner as Example 1, except that in the Dispersion B, the developer NKK-1304 was replaced by 4-Hydroxyphenyl sulfone (trade name “BPS”), which is represented by the formula:

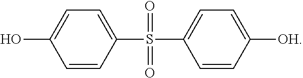 [SMILES: O=S(=O)(c1ccc(O)cc1)c1ccc(O)cc1]

Comparative Example 7: A record material was made in the same manner as Example 1, except that in the Dispersion B, the developer NKK-1304 was replaced by 4-Benzyloxyphenyl-4′-hydroxyphenyl sulfone (trade name “BPS-MBE”), which is represented by the formula:

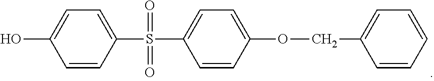 [SMILES: O=S(=O)(c1ccc(O)cc1)c1ccc(OCc2ccccc2)cc1]

Comparative Example 8: A record material was made in the same manner as Example 1, except that in the Dispersion B, the developer NKK-1304 was replaced by 2,2′-Diallyl-4,4′Sulfonyldiphenol (trade name “TGSH”), which is represented by the formula:

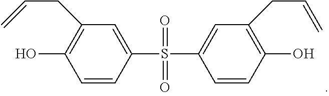 [SMILES: C=CCc1cc(S(=O)(=O)c2ccc(O)c(CC=C)c2)ccc1O]

Comparative Example 8-SS: A record material was made in the same manner as Comparative Example 8, except that the 3 pt. SmartSolve™ dispersible paper referenced above was used as the substrate instead of the Neenah Dispersa™ dispersible paper.

Comparative Example 9: A record material was made in the same manner as Example 1, except that in the Dispersion B, the developer NKK-1304 was replaced by 1-butyl-3-(4-methyl phenyl) sulfonyl urea (trade name “Tolbutamide”), which is represented by the formula:

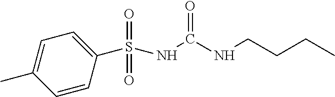 [SMILES: CCCCNC(=O)NS(=O)(=O)c1ccc(C)cc1]

Comparative Example 10: A record material was made in the same manner as Example 1, except that in the Dispersion B, the developer NKK-1304 was replaced by N-(p-Toluenesulfonyl)-N′-(3-p-toluenesulfonyloxyphenyl)urea (trade name “Pergafast 201”) from Solenis LLC, which is represented by the formula:

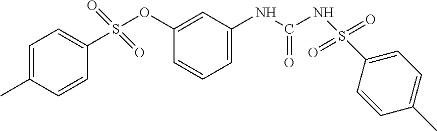

Comparative Example 10-SS: A record material was made in the same manner as Comparative Example 10, except that the 3 pt. SmartSolve™ dispersible paper referenced above was used as the substrate instead of the Neenah Dispersa™ dispersible paper.

Additional comparative examples were also fabricated in which the dispersible paper substrate was replaced with a “standard” (neither water-dispersible nor water-dissolvable) paper substrate. The standard paper substrate that was used was an uncoated free sheet having a basis weight of 62 gsm. For reference purposes, we use the suffix “-Std” to designate these comparative examples. Thus, we made a direct thermal recording material substantially the same as Example 1 except that the Dispersa™ substrate was replaced with the standard paper substrate, and we refer to it as Comparative Example 1-Std, and likewise for Examples 2, 3, and 4, whose counterpart comparative examples (containing the standard paper substrate rather than the Dispersa™ substrate) we refer to as Comparative Examples 2-Std, 3-Std, 4-Std, respectively. Similarly, a direct thermal recording material like that of Comparative Example 5 was made except that the Dispersa™ substrate was replaced with the standard paper substrate, and we refer to it as Comparative Example 5-Std, and likewise for Comparative Examples 6, 7, 8, 9, and 10.

Pertinent characteristics of the above Examples and Comparative Examples are summarized, for convenience, in Table 7:

TABLE 7
Summary Characteristics of Examples, Comparative Examples

| Example/Comp. Ex. | substrate | leuco dye | developer |
|---|---|---|---|
| 1 | Dispersa ™ | ODB-2 | NKK-1304 |
| 1-SS | SmartSolve ™ | ODB-2 | NKK-1304 |
| CE 1-Std | (standard) | ODB-2 | NKK-1304 |
| 2 | Dispersa ™ | ODB-2 | TGMD |
| 2-SS | SmartSolve ™ | ODB-2 | TGMD |
| CE 2-Std | (standard) | ODB-2 | TGMD |
| 3 | Dispersa ™ | ODB-2 | S-176 |
| 3-SS | SmartSolve ™ | ODB-2 | S-176 |
| CE 3-Std | (standard) | ODB-2 | S-176 |
| 4 | Dispersa ™ | ODB-2 | UU & DPU (50:50) |
| CE 4-Std | (standard) | ODB-2 | UU & DPU (50:50) |
| CE 5 | Dispersa ™ | ODB-2 | D-8 |
| CE 5-SS | SmartSolve ™ | ODB-2 | D-8 |
| CE 5-Std | (standard) | ODB-2 | D-8 |
| CE 6 | Dispersa ™ | ODB-2 | BPS |
| CE 6-Std | (standard) | ODB-2 | BPS |
| CE 7 | Dispersa ™ | ODB-2 | BPS-MBE |
| CE 7-Std | (standard) | ODB-2 | BPS-MBE |
| CE 8 | Dispersa ™ | ODB-2 | TGSH |
| CE 8-SS | SmartSolve ™ | ODB-2 | TGSH |
| CE 8-Std | (standard) | ODB-2 | TGSH |
| CE 9 | Dispersa ™ | ODB-2 | Tolbutamide |
| CE 9-Std | (standard) | ODB-2 | Tolbutamide |
| CE 10 | Dispersa ™ | ODB-2 | Pergafast 201 |
| CE 10-SS | SmartSolve ™ | ODB-2 | Pergafast 201 |
| CE 10-Std | (standard) | ODB-2 | Pergafast 201 |

All of the samples in Table 7 were phenol-free or substantially phenol-free. Samples of the above Example and Comparative Example direct thermal recording materials were then subjected to various tests and measurements.

In a first test, samples were given a direct thermal barcode image using a Zebra™ model 140-401 thermal printer, at a standard speed of 6 ips at factory default heat setting (nominally 11.7 mJ/mm²). The quality of the resulting bar code image was then assessed according to the American National Standards Institute (ANSI) barcode methodology, using a calibrated TruCheck™ Barcode Verifier, model TC-843, operating at a wavelength of 650 nm, and also separately measured using a calibrated TruCheck™ Barcode Verifier, model TC-854, operating at a wavelength of 670 nm. We refer to the output of each of these devices as an “Initial” ANSI value for the tested barcode image. An ANSI value of at least 1.5 indicates a passing score, i.e., that the image is reliable for machine barcode reading. An ANSI value less than 1.5 is a failing score, and indicates the image cannot be reliably read using a machine barcode reader. In all relevant tests we performed on the samples, the two separate ANSI values (one measured at 650 nm with the TC-843, the other measured at 670 nm with the TC-854) were in agreement, i.e., they were either both “pass” (at least 1.5) or both “fail” (less than 1.5).

Some of the samples that were thermally printed in the manner described above were then afterwards subjected to a “heat only” test. Here, a given sample that had been imaged with a direct thermal image was placed in a temperature-controlled environment of hot air at 60° C. for 24 hours, and then removed and allowed to cool to ambient room temperature. The humidity in the temperature-controlled environment was low, less than 20% RH. The quality of the image was then re-measured using the TruCheck devices.

Some of the samples were subjected to a “post-40/90” test. Here, a given sample that had already been imaged with a direct thermal image as described above, but that had not been subjected to the “heat only” test, was placed in a chamber whose temperature and humidity was controlled. The temperature was controlled to 40° C. and the relative humidity was controlled to 90%. After 24 hours in the chamber, the sample was removed, allowed to cool to ambient room temperature, and the quality of the image was re-measured using the TruCheck devices.

Some of the samples were subjected to a “post-60/90” test. This was substantially the same as the “post-40/90” test (and was performed on samples that had already been thermally imaged but had not otherwise been subjected to any heated environments), but where the chamber was controlled to a temperature of 60° C. and a relative humidity of 90%. After removal from the hot, humid environment and after being allowed to cool, the quality of the image was re-measured using the TruCheck devices.

Some of the samples were subjected to a “pre-40/90” test. Here, a given sample that had not yet been imaged, and that had not been subjected to the “heat only” test or any other heated environment, was placed in a chamber whose temperature and humidity was controlled. The temperature was controlled to 40° C. and the relative humidity was controlled to 90%. After 24 hours in the chamber, the sample was removed and allowed to cool to ambient room temperature. Then, the sample was given a direct thermal barcode image using the same Zebra™ 140-401 thermal printer mentioned above, and at the same print settings. The quality of the image so made was measured using the TruCheck devices described above.

The results of these tests were as follows:

TABLE 8
Tests on Samples (Comparative Examples) Having a Standard
Paper Substrate

| | “Initial” | “Heat Only” | “Post—-40/90” | “Pre—-40/90” |
|---|---|---|---|---|
| Sample | ANSI | ANSI | ANSI | ANSI |
| CE 1-Std | pass | pass | pass | pass |
| CE 2-Std | pass | pass | pass | pass |
| CE 3-Std | pass | pass | pass | pass |
| CE 4-Std | pass | pass | pass | pass |
| CE 5-Std | pass | pass | pass | pass |
| CE 6-Std | pass | pass | pass | pass |
| CE 7-Std | pass | pass | pass | pass |
| CE 8-Std | pass | pass | pass | pass |
| CE 9-Std | pass | pass | pass | pass |
| CE 10-Std | pass | pass | pass | pass |

The results in Table 8 demonstrate that there were no image fade or image formation problems for samples that used a conventional paper substrate.

TABLE 9
Tests on Samples Having a Dispersa ™ Paper Substrate

| | “Initial” | “Heat Only” | “Post—40/90” | “Pre—40/90” |
|---|---|---|---|---|
| Sample | ANSI | ANSI | ANSI | ANSI |
| 1 | pass | pass | pass | pass |
| 2 | pass | pass | pass | pass |
| 3 | pass | pass | pass | pass |
| 4 | pass | pass | pass | pass |
| CE 5 | pass | pass | fail | fail |
| CE 6 | pass | pass | fail | fail |
| CE 7 | pass | pass | fail | fail |
| CE 8 | pass | pass | fail | fail |
| CE 9 | pass | pass | fail | fail |
| CE 10 | pass | pass | fail | fail |

The results in Table 9 demonstrate that when the Dispersa-brand water dispersible substrate was used to make phenol-free direct thermal recording materials, all of the samples passed the initial and “heat only” tests, but only the samples that used a developer comprising a derivative of N,N′-diphenylurea avoided an unacceptable image fade problem and an unacceptable image formation problem associated with the extended high heat/high humidity tests.

TABLE 10
Tests on Samples Having a SmartSolve ™ Paper Substrate

| | “Initial” | “Heat Only” | “Post—40/90” | “Pre—40/90” |
|---|---|---|---|---|
| Sample | ANSI | ANSI | ANSI | ANSI |
| 1-SS | pass | pass | pass | pass |
| 2-SS | pass | pass | pass | pass |
| 3-SS | pass | pass | pass | pass |
| CE 5-SS | pass | pass | fail | fail |
| CE 8-SS | pass | pass | fail | fail |
| CE 10-SS | pass | pass | fail | fail |

The results in Table 10 are similar to those of Table 9, and demonstrate that when the SmartSolve-brand water dispersible substrate was used to make phenol-free direct thermal recording materials, all of the available samples passed the initial and “heat only” tests, but only the samples that used a developer comprising a derivative of N,N′-diphenylurea avoided an unacceptable image fade problem and an unacceptable image formation problem associated with the extended high heat/high humidity tests.

TABLE 11
Tests—Including Higher Temperature Tests—on Examples 1 through 4

| | “Initial” | “Heat Only” | “Post—40/90” |
|---|---|---|---|
| Sample | ANSI | ANSI | ANSI |
| 1 | pass | pass | fail |
| 2 | pass | pass | fail |
| 3 | pass | pass | pass |
| 4 | pass | pass | fail |

The “Initial” and “Heat Only” results in Table 11 are simply repeated from Table 9, but the results in the final column “Post-60/90” demonstrate that Example 3, which uses S-176 for the developer in the thermally responsive layer, is even more robust in that regard than the other three Examples.

Unless otherwise indicated, all numbers expressing quantities, measured properties, and so forth used in the specification and claims are to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application. Not to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

The use of relational terms such as “top”, “bottom”, “upper”, “lower”, “above”, “below”, and the like to describe various embodiments are merely used for convenience to facilitate the description of some embodiments herein. Notwithstanding the use of such terms, the present disclosure should not be interpreted as being limited to any particular orientation or relative position, but rather should be understood to encompass embodiments having any orientations and relative positions, in addition to those described above.

Various modifications and alterations of this invention will be apparent to those skilled in the art without departing from the spirit and scope of this invention, which is not limited to the illustrative embodiments set forth herein. The reader should assume that features of one disclosed embodiment can also be applied to all other disclosed embodiments unless otherwise indicated. All U.S. patents, patent application publications, and other patent and non-patent documents referred to herein are incorporated by reference, to the extent they do not contradict the foregoing disclosure.

What is claimed is:

1. A recording medium, comprising:
a substrate; and
a thermally responsive layer carried by the substrate, the thermally responsive layer including a leuco dye and at least one developer;
wherein the recording medium is substantially phenol-free; and
wherein the at least one developer comprises an N,N′-diphenylurea derivative selected from S-176 and TGMD.

2. The medium of claim 1, wherein the developer comprises S-176.

3. The medium of claim 1, wherein the developer comprises TGMD.

4. The medium of claim 1, wherein the developer comprises S-176 and TGMD.

5. The medium of claim 1, wherein the substrate comprises a water-soluble paper or water-dispersible paper.

6. The medium of claim 5, comprising a base coat between the substrate and the thermally responsive layer.

7. The medium of claim 6, wherein the base coat includes a non-water-soluble binder.

8. The medium of claim 4, wherein the substrate comprises a water-soluble or water-dispersible paper.

9. The medium of claim 1, wherein a print quality of the recording medium when printed with a thermal printer energy setting of 11.7 mJ/mm² at a print speed of 6 inches per second (ips) is characterized by an ANSI value of at least 1.5.

10. The medium of claim 9, wherein the print quality of the printed recording medium is characterized by an ANSI value of at least 1.5 even where, before the thermal printing is performed, the recording medium is exposed to air at 40° C. and 90% relative humidity for 24 hours, then removed and cooled.

11. The medium of claim 9, wherein the print quality of the printed recording medium is still characterized by an ANSI value of at least 1.5 after the printed recording medium is exposed to air at 40° C. and 90% relative humidity for 24 hours, then removed and cooled.

12. The medium of claim 1, further comprising a top coat carried by the substrate such that the thermally responsive layer is disposed between the top coat and the substrate.

13. The medium of claim 1, wherein the thermally responsive layer has a coat weight of 2.5 to 7.5 g/m².

14. The medium of claim 1, wherein the at least one developer comprises S-176 and a print quality of the recording medium when printed with a thermal printer energy setting of 11.7 mJ/mm² at a print speed of 6 inches per second (ips) is characterized by an ANSI value of at least 1.5.

15. The medium of claim 14, wherein the print quality of the printed recording medium is characterized by an ANSI value of at least 1.5 even where, before the thermal printing is performed, the recording medium is exposed to air at 40° C. and 90% relative humidity for 24 hours, then removed and cooled.

16. The medium of claim 15, wherein the print quality of the printed recording medium is still characterized by an ANSI value of at least 1.5 after the printed recording medium is exposed to air at 40° C. and 90% relative humidity for 24 hours, then removed and cooled.

17. The medium of claim 1, wherein the at least one developer comprises TGMD and a print quality of the recording medium when printed with a thermal printer energy setting of 11.7 mJ/mm² at a print speed of 6 inches per second (ips) is characterized by an ANSI value of at least 1.5.

18. The medium of claim 17, wherein the print quality of the printed recording medium is characterized by an ANSI value of at least 1.5 even where, before the thermal printing is performed, the recording medium is exposed to air at 40° C. and 90% relative humidity for 24 hours, then removed and cooled.

19. The medium of claim 18, wherein the print quality of the printed recording medium is still characterized by an ANSI value of at least 1.5 after the printed recording medium is exposed to air at 40° C. and 90% relative humidity for 24 hours, then removed and cooled.
